(19) United States
(12) Patent Application Publication
(10) Pub. No.: US 2005/0019242 A1
(43) Pub. Date: Jan. 27, 2005

(54) Method for the manufacture of a metal oxide or nitride powder or a semiconductor oxide or nitride powder, an oxide or nitride powder made thereby, and solids and uses thereof

(75) Inventors: Bernard Serole, Peyrins (FR); Michelle Serole, Peyrins (FR)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: W.C. Heraeus GmbH & Co. KG

(21) Appl. No.: 10/878,776

(22) Filed: Jun. 28, 2004

Related U.S. Application Data
(63) Continuation-in-part of application No. PCT/EP03/04780, filed on May 7, 2003.

(30) Foreign Application Priority Data
May 10, 2002 (FR) 02/05784

(51) Int. Cl. C01B 21/06

(52) U.S. Cl. 423/325; 423/594.9; 423/594.7; 423/409

(57) ABSTRACT

A method is provided for the production of a oxide or nitride in a nanostructure with a high electric conductivity, for example indium-tin-oxide or aluminum nitride. The method produces an oxide or nitride powder useful to form a solid, which can be used as a sputter target. The oxide or nitride is produced by a synthesis reaction while the liquid alloy is sputtered in a very hot plasma. The synthesis reaction is initiated at a very high temperature, followed by a thermal state that is controlled such that it yields a crystalline structure, which is free from any defects and permits a high mobility of electric charges.

### CROSS-REFERENCE TO RELATED APPLICATION

This is a continuation-in-part of International Application No. PCT/EP03/04780, filed May 7, 2003, the disclosure of which is incorporated herein by reference.

### BACKGROUND OF THE INVENTION

The invention relates to a method for the manufacture of a metal oxide or nitride powder or a semiconductor oxide or nitride powder. The invention further relates to an oxide or nitride powder so produced, solids manufactured therefrom and their use.

A main field of application of the present invention is the ITO or indium-tin-mixed oxide, which is a transparent and electrically conducting ceramic material. This particular property permits quite a few applications, such as the preparation of thin films for liquid crystal or plasma displays, electromagnetic shielding, heating devices, or other systems, mostly on glass or plastic. An important area of application is cathode sputtering on glass, which requires as high an electric conductivity as possible and which is followed by an etching cycle. In cathode sputtering, more or less large parts of the target material are removed by ionic bombardment and deposited on a substrate. That is the reason why the properties of the deposition layer on a substrate depend largely, though not exclusively, on the properties of the target.

ITO is a semiconductor that has the property of being transparent over a wide wavelength range. Its high conductivity is based on a high concentration of charge carriers with a high mobility. The conductivity (C) is equal to the product of the number (N) and the mobility (M) of the charge carriers:
C=N×M

ITO is an indium oxide (In₂O₃) that is doped with tin atoms. In this process, certain indium atoms belonging to Group III of the Periodic Table of the elements are replaced by tin atoms belonging to Group IV of the Table. This results in an excess of electrons and, thus, of charge. Charge carriers are the electrons which, owing to the tin atoms (Sn atoms) and the oxygen vacancies (Vo), are present in excess. Both their concentrations are of the same characteristic magnitude of weakly conducting materials, that is:
Sn*=Vo=3×10²⁰ cm⁻³

Unfortunately, only a small part of these electrons is mobile, because of an unfavorable structure. The mobility is measured by means of the Hall effect, which is based on a deflection of the field lines of a current-carrying conductor through a magnetic field. The mobility is reduced by structural defects of the crystal lattice.

Other oxide or non-oxide ceramics, for example nitrides, and in particular aluminum nitride, which do not have the interesting peculiarity of transparency, may nevertheless be electrically conducting under certain conditions or have other interesting features, which can also be useful, as will be discussed further below. Apart from the fineness and the properties of nano-materials, it is particularly known that thermal conductivity is, in general, correlated with electric conductivity.

According to the state of the art, most of the target materials for cathode sputtering, various parts, granulates, and powders are manufactured today by mixing indium oxide and tin oxide powders according to wet-chemical procedures. These powders are mixed at variable ratios, wherein a weight mix ratio of 90% indium oxide to 10% tin oxide is used in most cases. The mixture will be more homogeneous if the hydroxides are mixed and subsequently dried.

Thereafter, this powder is compacted by sintering, hot isostatic pressing (commonly known as HIP), hot pressing or by other similar methods. In this context, reference should be made to the diagram in FIG. 1 of the publication by H. Enoki, E. Echigoya and H. Suto, “The intermediate compound in the In₂O₃—SnO₂ system,” Journal of Materials Science, 4110-4115 (1991). It can be seen therefrom that the two phases are at the edges of the diagram—the C1 and T zones of FIG. 1—and that the desired zone represented by the vertical dotted line is the zone where the tin oxide is in the mixed crystal in the indium oxide, hence in the C1 zone, where the temperature is close to 1200° C. The diagram should not be seen as a constitution diagram resulting from reversible cooling. All the same, the diagram reveals that the desired product results from a diffusion into the solid state, which is intricate and requires much special knowledge from persons who are familiar with this subject matter. The C1 zone would consist of (In,Sn)₂O₃ and the C2 zone of (In₀₆—Sn_{0.4})₂O₃.

At a ratio of 90 to 10, as represented by the dotted line in FIG. 1, it can be seen that tin oxide SnO₂ precipitates slowly and at a low temperature, with this precipitation becoming stronger above 1000° C.

The method according to French Patent FR 9410874 yields a completely different ITO. The manufacturing process is the subject of FR 9410874. The results, i.e., the properties of the manufactured powder, are described in detail in European Patent EP 0 879 791 B1.

The metal alloy is melted at a material amount ratio which provides, after oxidation, the desired oxygen value of, for example, 89.69 wt % indium and 10.31 wt % tin, corresponding to 36 atom % indium, 4 atom % tin and 60 atom % oxygen, resulting in a weight ratio of 90 to 10 (indium oxide to tin oxide). The liquid is completely homogeneous and proceeds in the form of a calibrated jet, which is a few millimeters in diameter, into a plasma that preferably consists of pure oxygen. The oxygen reaction begins at a very high temperature in an environment with a very high enthalpy. Oxidation takes place at the very finely sputtered alloy. In reality, the plasma consists of O₂, O₂⁺, O²⁺, O, O⁺, In, In⁺, Sn, and Sn⁺ particles at material amount ratios that depend on the enthalpy and are difficult to determine. The oxide is a mixed oxide, that is, an oxide whose crystal lattice has a triperiodic structure, where the indium, tin and oxygen atoms are distributed regularly over positions which lie in the vicinity of those positions that can be predicted according to Morse's law, which specifies the equilibrium between the potentials of attraction and repulsion of the two atoms. The velocity of ejection from the plasma nozzle is in the supersonic region. Moreover, the natural cooling rate outside of the exothermic reaction is 10⁴° K/sec. Hence, a complete oxidation takes 2 to 3 seconds at this reaction rate.

The reaction time specified may be very short for two reasons. The first reason is a quenching process during the flight, if the heat balance of the reaction in a grain is negative, i.e., if the heat of combustion fails to equalize the cooling process. The second reason is the contact with solids, mainly with the walls of the reaction chamber. In either case, and even if the powder continues burning in the agglomerates, the theoretical structure fails to be reached. The grains have a mean diameter of 1 to 20 μm. Nevertheless, they agglomerate with each other at the slightest touch.

The compaction of the powder to form solids, which are at present usually provided for manufacture of targets for cathode sputtering, is achieved by a classical combination of cold and hot pressing or by unidirectional hot pressing or hot isostatic pressing (HIP). In all cases, the heating temperature exceeds 900° C. In German Patent DE 44 27 060 C1 a temperature of over 800° C. is claimed for powders of 2 μm and 20 μm.

Moreover, U.S. Pat. No. 5,580,641 describes the application of ion implantation of O⁺ ions to reduce the number of charge carriers. Conversely, the implantation of hydrogen ions is treated in “Studies of H₂⁺ implantation into indium tin film oxides,” Nuclear Instrumentation Methods, 37.37:732 (1989). The method of ion implantation is common knowledge.

The method known from U.S. Pat. No. 4,689,075 is a static one. A specific amount of a granulate mixture or tablets is placed on an anvil and removed at a high temperature by means of a plasma torch that is apparently similar to those available on the market for cutting and welding purposes. Such torches consist of a stationary tungsten electrode that is surrounded by a number of gas jets.

It seems that the two components, which are subjected to an intense thermal motion, evaporate at the same time and that the vapors can be caught by being sucked in, whereby a high-quality mixture is formed—as claimed. Conversely, our method does not contain any mixture and is not based on thermal motion.

The method according to the cited patent is a static one and operates batchwise, although a more or less automatic charging is also conceivable for its industrial applicability, which leads to the processing of successive batches.

U.S. Pat. No. 4,889,665 follows the above-cited patent. It claims the use of a plasma torch for heating an amount of granulate or compacted sintered parts.

U.S. Pat. No. 6,030,507 describes the production of coarser powders with grain sizes of 1 to 20 μm.

U.S. Pat. No. 5,876,683 describes a different technique. Concretely, it is based on the chemical combustion of an organic precursor in a flame. The precursor mentioned is already a metal compound. For example, silazanes, butoxides (CH₂CH₂CH₂CO₂—), acetyl (CH₃COCH₂—), or acetonates are disclosed.

### BRIEF SUMMARY OF THE INVENTION

The invention aims at improving the state of the art and at providing an appropriate method, an oxide or nitride powder and a solid, as well as the use of the latter.

This object is achieved by a method for producing a metal oxide or nitride powder or a semiconductor oxide or nitride powder, comprising oxidizing or nitriding the metal or semiconductor material for the oxide or nitride powder in an oxygen or nitrogen plasma. The metal or semiconductor material assumes the function of a melt-down electrode in the oxygen or nitrogen plasma, such that the metal or semiconductor material undergoes a dynamic, continuous and direct oxidation or nitridation. The time of flight of developing oxide or nitride particles in the plasma is sufficient for a complete oxidation or nitridation reaction without any mechanical contact before cooling down completely, and the oxidation or nitridation step is followed by a controlled cooling phase. The method preferably includes a powder compaction phase by sintering or hot pressing at a temperature in a range of about 550° C. to 800° C., preferably in a range of about 600° C. to 700° C.

The object is further achieved by an oxide or nitride powder comprising a nanopowder having a grain size of less than 0.5 μm, wherein grains of the nanopowder comprise crystallites smaller than 100 nm. The nanopowder is preferably formed of at least one oxide of the group including indium-tin-oxide, tin oxide, bismuth oxide, zinc oxide, silicon oxide, and antimony oxide. Where the nanopowder is formed from silicon oxide, the silicon oxide is preferably sub-stoichiometric. The nanopowder may be produced by the above method. In the case of the nitrides, the nanopowder is preferably formed of aluminum nitride or silicon nitride, although other nitrides are conceivable.

Solids may be formed from the above nanopowder, wherein the solid has a density of at least 99% of theoretical density. The solid may be advantageously used, for example, as a sputter target.

The method is a dynamic and continuous one. The constituents are present in the fluid state. The first component of the reaction (metal, alloy or mixture) flows in the fluid state or, equivalently, in continuous form. It assumes two roles. On the one hand, it is one of the components of the reaction and can be found in the plasma. For example, an analysis of the plasma will identify electrons, ions from the gases—whether oxygen, nitrogen, argon, hydrogen—and bismuth, indium, and tin ions. On the other hand, it also assumes the role of a tungsten electrode which would, however, melt down and become smaller to an unlimited extent.

The complex method comprises four phases:

Phase 1

The plasma is only a part of the method according to the invention. The plasma certainly represents an important preparation phase. In the plasma, the reaction begins under ideal thermodynamic conditions. Both enthalpy and entropy are positive to a high degree. What is more, the thermal motion of the atoms and molecules is an improvement factor.

Phase 2

Although new in concept, the plasma itself would not allow continuous production. In the method according to the invention, the plasma is sucked in by a strong dynamic negative pressure in a burning point or a combustion chamber of reduced dimensions. It should be noted that the plasma is a mixture that consists of molecules, molecules with dissociated atoms, molecules of ionized gases, ionized atoms, metallic vapors, and electrons. This mixture is sucked off as it is formed in the combustion chamber.

Phase 3

The third phase is the sputtering phase. The mixture formed by the plasma is accelerated by a supersonic nozzle to a high velocity on the order of multiples of the velocity of sound. This acceleration disperses the components at a small and well-defined angle into a more or less unlimited volume. A production of 100 kg/hour, which is blown at by a jet of 500 m/sec, is dispersed at a rate of 55 mg per meter. Since the jet is designed such that it widens as it decelerates, this dilution rate is preserved until cooling is completed, thus preventing the formation of satellites and agglomeration.

Phase 4

The fourth phase is the transport phase. The reaction initiated in the preceding phases is continued and ends under controlled thermodynamic conditions, while maintaining an interstice between the forming grains, so that these grains may undergo their individual development without coming into contact with other grains or with the walls. This permits development and maintenance of the nanostructure initiated by the plasma.

Studies of various materials have shown that the method according to the invention permits the continuos production and not the batch production of powders from compounds complying with the definition of nanopowders.

By introducing the basic materials of the continuous reaction into the plasma (plasma bubble with a volume of 1 to 3 cm³), for example the liquid In Sn alloy, on the one hand, and separately pure oxygen or nitrogen, on the other hand, it is not a mixture that is obtained, but a compound.

The nanograins may tend to gather under the effect of various factors. These factors are moisture, static electricity and various surface parameters that are correlated with their dimensions of a magnitude of several atomic diameters, as well as with their extreme surface-to-mass ratio. Actually, these forces are weak interactive forces, but they may have a considerable influence because of the large specific surface of the nanopowder.

Under these conditions, it may be considered that these surface forces provide grain agglomerates, which may even reach the submicron range, with a certain strength that may, however, break apart because of a low moisture content or a certain ultrasonic excitation.

Under these conditions that are measured with a modern laser granulometer, the following must be maintained after an ultrasonic dispersion for a duration of approximately 2 minutes: d₅₀ by weight <0.50 μm. This means that 50% of the weight-based amount of powder has a grain size of less than 0.50 μm.

It must be noted that the interruption or prolongation of phase 4 reasonably permits a total or a partial reaction, and this with an entirely new degree of precision.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is an indium oxide/tin oxide phase diagram;

FIG. 2 is a plasma temperature-enthalpy diagram;

FIG. 3 is a schematic diagram showing the temperature spectrum along the reaction path;

FIG. 4 is a graph of specific surface area relative to powder grain size;

FIG. 5 is a schematic diagram showing defects according to Frenkel (left) and Schottky (right);

FIG. 6a is a schematic diagram showing a foreign atom that replaces an atom (a) or occupies an interstitial position (b);

FIG. 6b is a schematic diagram showing an edge displacement perpendicular to the plane of the drawing;

FIG. 6c is a schematic diagram showing a screw displacement;

FIG. 7 is a schematic diagram of an apparatus for carrying out the method of the present invention; and

FIG. 8 is a schematic detail diagram of the circled nozzle area 8 of the diagram of FIG. 7.

### DETAILED DESCRIPTION OF THE INVENTION

The invention will now be described in detail with particular reference to the manufacture of metal oxide powders using an oxygen plasma, as an example. However, it will be understood by those skilled in the art that the same or similar principles and techniques as those described below may be used and/or modified to manufacture metal nitride powders using a nitrogen plasma, or to manufacture semiconductor oxide or nitride powders using an oxygen or nitrogen plasma, respectively.

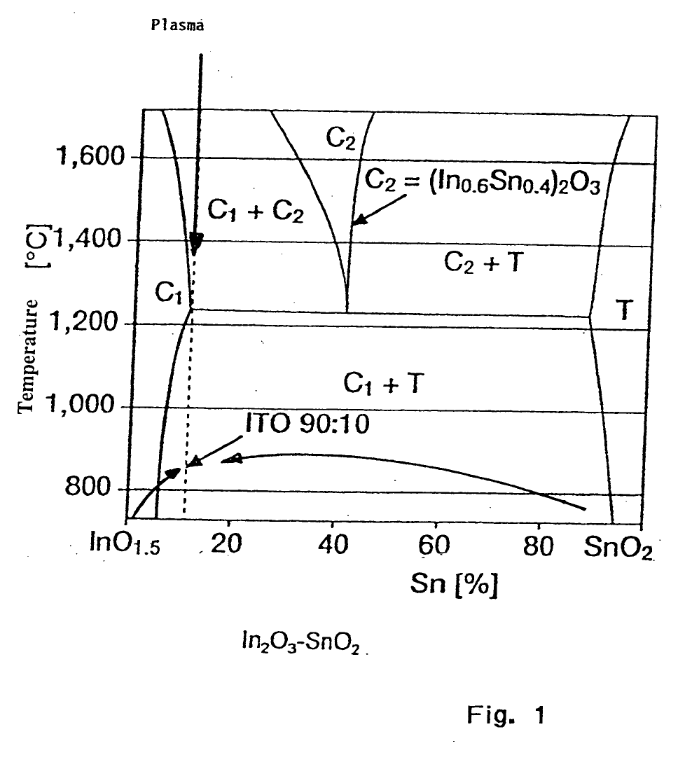

The method according to the invention proceeds from the principle that the plasma only offers the possibility of discussing the diagram according to FIG. 1. The likewise fine mixing method, i.e., the procedure carried out on the basis of hydroxides, is not covered by the diagram.

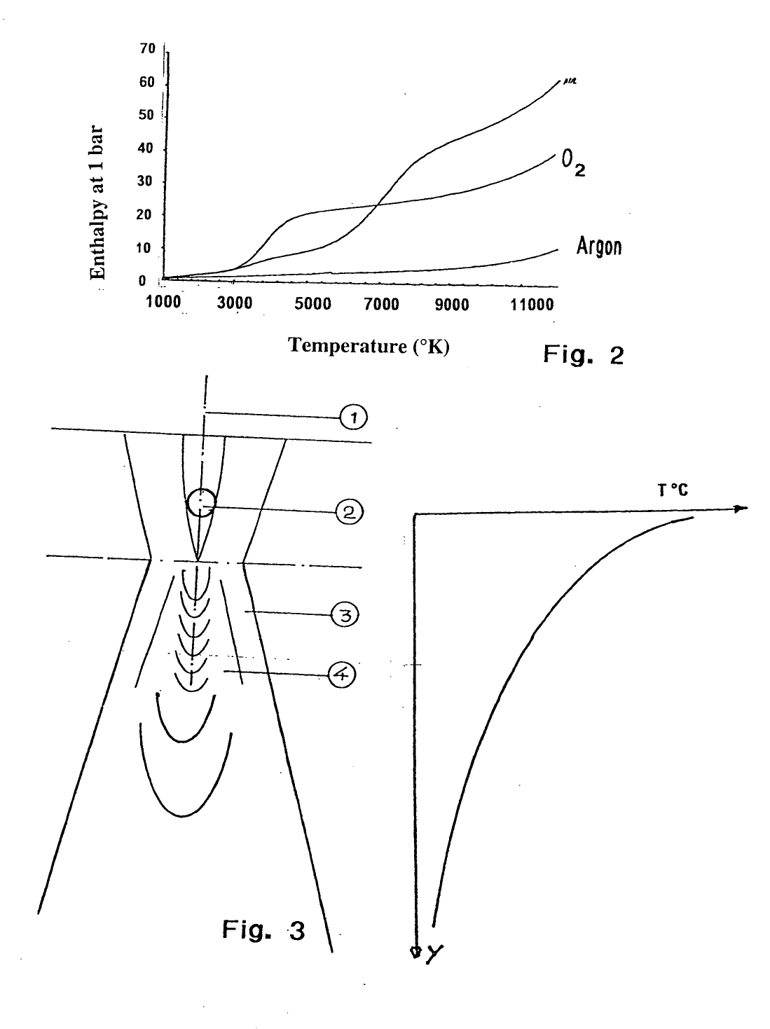

The oxygen plasma method starts the reaction at a temperature of a magnitude of 10,000° C. FIG. 2 shows the plasma temperature as a function of the enthalpy of the system. The oxidation reaction takes place instantaneously and is exothermic. In contrast, a zone of a cold atomization gas surrounding the plasma forms behind (downstream of) the nozzle which provides the flow and the sputtering. The following table reflects the properties of the jet for a standard nozzle. These values have been verified in experiments.

| Properties | Inlet | Outlet |
|---|---|---|
| Pressure [bar] | 7 | 0.95 |
| Temperature [° K] | 293 | 165 |
| Mach number | 0 | 1.96 |
| Velocity [m/sec] | 0 | 483 |

The liquid metal jet flows at a velocity of approx. 3 m/sec into an outlet tube, 2.5 mm in diameter, under a metallostatic head of 500 mm (height of the liquid metal above the outlet).

The plasma is sucked in at a velocity that is below that of the atomization gas. In view of the as-defined fineness of the plasma components, the mixture can be considered to be homogeneous.

FIG. 3 shows the calculated temperature spectrum that has been verified by laser measurement. The liquid alloy jet at a temperature of, for example, 670° K is identified by the axis 1 of the cast jet; the plasma cone (plasma bubble) at 10,000° K is identified by 2; and the oxygen at Mach 1.96 and 165° K through the zone of the cold atomization gas surrounding the plasma is identified by 3. The area 4 is the reaction and cool-down zone where a homogeneous environment can be assumed and where cooling-down is achieved according to a cubic law.

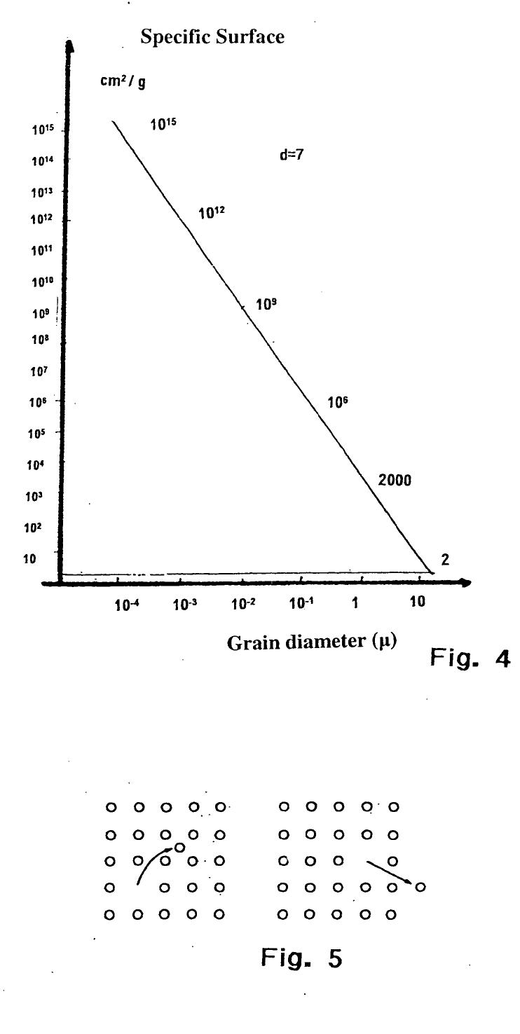

In particular, the method according to the invention provides the forming ITO particles with a free flight path according to the time required for complete reaction and then controls the cooling phase. Calculations and experiments have shown that, at a velocity of ejection from the nozzle of approximately 480 m/sec and with the relation among the velocities that follow a cubic correlation, i.e., a power of ⅓ of the path, a free flight path of a magnitude of at least 5 meters is required. The reaction must be completed in the flight section where the plasma is the determinant, that is above 1000° C. For that reason, this range or this section of the flight path must have an appropriate length of approximately 2 to 3 meters. Subsequently, the generated structure must be maintained in order to avoid separations, in particular of tin oxide. In this manner, a powder consisting of grains of nanometer magnitude is obtained. Their mean diameter is less than 1/100 μm, i.e., tens of Angstrom units. The powder manufactured in this manner has an extremely large specific surface area. FIG. 4 shows the curve of the specific surface area of a spheroidal powder in relation to the grain size.

As a result, the surface energy of the powder is far above that of powder manufactured according to prior art methods. The surface of the nanopowder is much larger, and the surface energy is proportional thereto.

In addition, the characteristic state of the powder in the phase diagram (FIG. 1) is located on the abscissa at 10% and on the ordinate at a very high temperature and, thus, outside the diagram. The analysis shows that the tin is in solid solution and has a structure that corresponds with the C1 zone. The diagram relates to an equilibrium state, and one can see that the atoms are very far from their minimum energy state, which they should assume according to the maximum flow theorem.

Once the powder has finally cooled down naturally upon completion of the reaction and at a faster rate thereafter and is still present as nanopowder, there are no obstacles to the displacement of particles in the lattice.

It should be noted that the nanopowder is not amorphous. In practice, the state of the nanopowder corresponds to the absence of identifiable powder grains. Examinations with a scanning electron microscope show ever finer grains as the magnification is increased.

This results in an absence of any and all structural defects. It can be considered to be proved that defects are the cause of low electric mobility. This is adequately shown by the fact that the electric conductivity of the depositions achieved by cathode sputtering increases by annealing, as well as by the fact that, in most cases, the ion implantation has reduced the conductivity proportionally to the number of defects it caused. The most damaging defects are formed at the grain boundaries of the powder. The grain boundaries represent an interruption in the crystal lattice. This interruption has different orientations and contains all contaminants that the hot surface has taken up from the atmosphere or by contact. While compaction is in progress, contaminants, such as carbon, are often displaced from the nucleus towards the periphery. The defect is eliminated by the absence of measurable grains and by the absence of any contact. The use of pure oxygen or clean gases prevents the take-up of contaminants during flight.

The microscopic contaminants must be attributed to the difference between the cooling rate and the rate that would be allowed by the formation of a crystal lattice, i.e., the time and the thermodynamic conditions required to ensure that each atom can assume its position.

There are three types of defects. Defects at atom positions are often called thermodynamic defects, because their presence in the crystals is often connected with high temperatures. These are Schottky defects if an atom is caused to leave its equilibrium position and Frenkel defects if a small cation likewise leaves its equilibrium position and migrates to an interstitial position. The Frenkel (left) and Schottky (right) defects are shown in FIG. 5. In the case of ITOs, the defects in the type of the atoms are of a structural nature, because the tin, together with the indium oxide, must be in solid solution. The foreign atom either takes the place of a crystal lattice atom or it occupies an interstitial position.

The following table specifies the metallic and ionic radiuses of the three elements considered here.

| O²⁻ | In | In³⁺ | Sn | Sn⁴⁺ |
|---|---|---|---|---|
| 1.32 | 1.66 | 0.92 | 1.58 | 0.74 |

This gives rise to the assumption that the tin atom may also occupy an interstitial position.

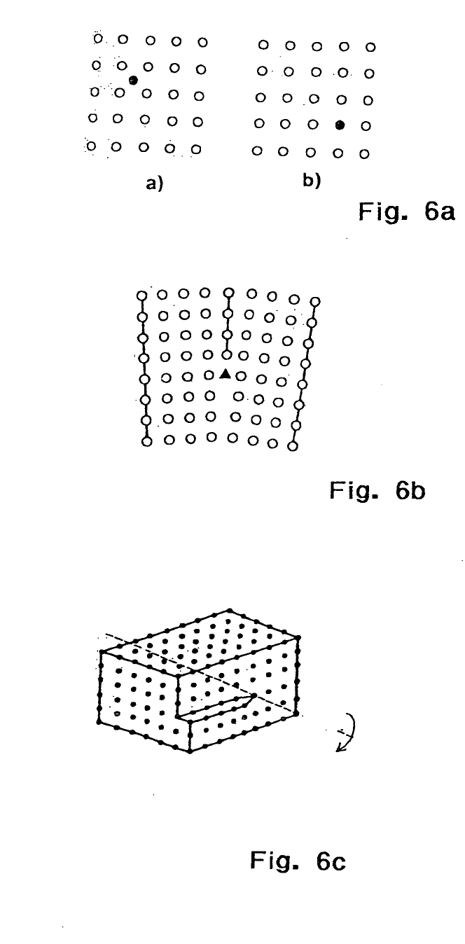

The defects and displacements are developed during the cooling phase. They are, above all, unavoidable whenever atoms have assumed interstitial positions, but they can be limited by a cooling process that is carried out at a slow rate and in a controlled manner. The three main types mentioned are the subject of FIGS. 6a-6c.

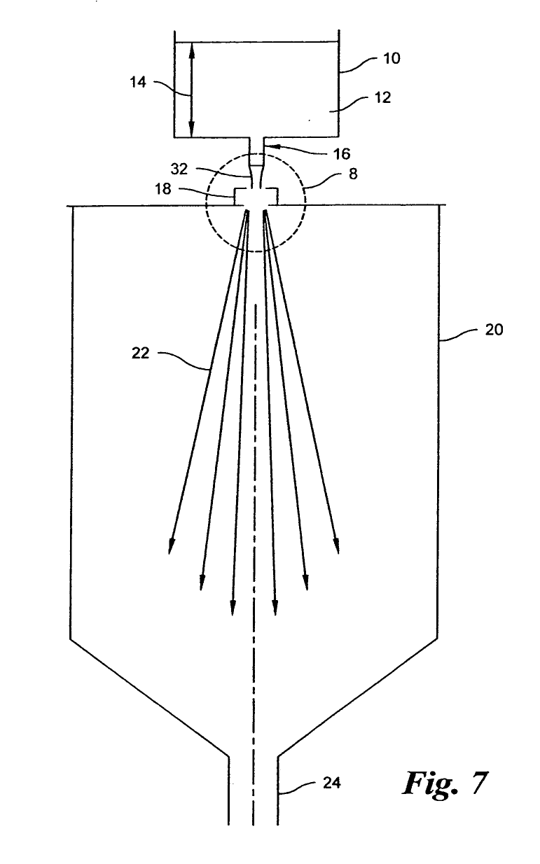

FIG. 7 shows a highly schematic illustration of an apparatus for carrying out the method of the present invention. A reservoir 10 holds the molten metal alloy 12 to produce a metallostatic head 14 above the liquid metal outlet 16, from where a calibrated stream of the molten metal flows into an oxygen plasma, which is sucked through a supersonic nozzle 18 into an atomization chamber 20. The chamber has sufficient length and width to allow transport of the particles of the atomized particle stream 22 over a flight path such as to permit complete reaction of the atomized molten metal and oxygen and to permit cooling of the particles before contact with the walls of the chamber 20 or with other particles. The oxide powder is discharged through the chamber outlet 24.

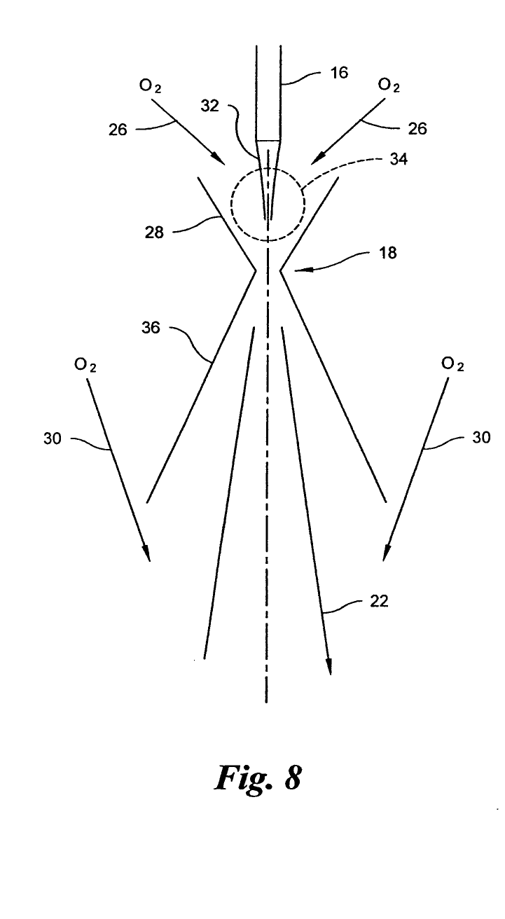

The reaction method is further illustrated with reference to FIG. 8, which is an enlarged schematic detail 8 of FIG. 7, showing the nozzle area of the apparatus of FIG. 7. Here, the calibrated stream of molten metal 32, flowing into a plasma mixture 34, serves both as the source of the metal component(s) for the powder and as an electrode for the reaction, while a plasma containment region 28 of the supersonic nozzle 18 serves as a counter-electrode (Phase 1). A stream of high temperature oxygen 26 is sucked into the plasma containment region 28 of the supersonic nozzle 18 at a velocity below that of the oxygen atomization gas 30 to mix with the stream of molten metal (Phase 2). The supersonic nozzle 18 accelerates the plasma mixture to a velocity greater than the speed of sound, using the oxygen atomization gas 30 to generate low pressure in the nozzle outlet 36 to draw the plasma mixture downwards (Phase 3). The nozzle outlet 36 widens to allow spreading and transport of atomized particle stream 22 over a small, well-defined angle to permit the complete reaction described above (Phase 4).

As can be concluded from the principle described above, the oxidation reaction is spontaneously started by the very high enthalpy and the state of the plasma. The reaction rate is also high. For example, the entire oxidation reaction can be completed within 5 seconds, although the ITO powder can burn stoichiometrically in the air for 20 minutes. As a consequence, the progression of the reaction can be completed by quenching at the end of a specified path at a degree of oxidation of 50, 60 or 90%, for example.

Thereafter, the cooling rate can and must be checked to ensure that the resulting crystal lattice will be as free from defects as possible. The cooling stage mentioned may be inadequate, either because of a negative heat balance or because of a contact with the wall of the reaction vessel. The first effect can be compensated by preheating or cooling the atomization gas, the second one by an appropriate routing of the gas flow in the reaction vessel. This can be properly achieved by an off-center injection of a suitable form and with the appropriate dimensions.

Conversely, it must be noted that the sub-stoichiometric manufacture of oxides, that are useful owing to their conductivity, can be achieved in an economical manner by gas quenching or by other mechanical devices on an exact path. To cool the jet abruptly from the point where it reaches an exact temperature, a probe defining the corresponding path was positioned, and a cooling gas injection was used whose effect is based on routing and dilution. It should be noted that air with a temperature of 20° C., whose pressure is reduced from 5 bar to 1 bar, is emitted at a temperature of −88° C.; the emission temperature of argon is −120° C.

The aforementioned 90/10-ITO powder has been produced according to the method of the present invention. It has the following properties:

| | |
|---|---|
| Primary particle size | nanostructure less than 0.10 μm |
| Powder density | 0.69 g/cm³ |
| Relative density | approx. 10% of the theoretical density |
| Resistivity (compacted) | 10⁻² ohms-cm or less |

The powder is heavy, is not suspended in air, and has an extremely excellent compaction behavior. Compaction occurs at a pressure as low as several kg/cm². To compact the powder mentioned, two classes of methods can be utilized that are well-known to those skilled in the art:

The manufacturing procedures using variants of the classical compaction and sintering method, particularly by pressing at ambient temperature after heating up to a high temperature, are modified as follows: The low-pressure compaction yields a higher density and strength, or the density obtained with the same pressure is higher and can exceed 80% of the theoretical density. Subsequently, the temperature in the present embodiment can be reduced from about 800° C. to at least about 600° C. or 650° C.

In the manufacturing procedures where use is made of variants of the hot pressing method, the temperatures are reduced in the same manner. These hot pressing processes can be implemented on hydraulic or mechanical presses, by hot isostatic pressing (HIP) or in a like manner. Irrespective of whether these pressing processes are preceded by a cold compaction process or not, the pressures/densities are improved, as is the case with the aforementioned compaction and sintering method.

The method has been tested and qualified for the oxidation of bismuth, zinc, silicon, and other elements under the conditions described above. Even aluminum nitride nanopowder can be manufactured in this manner in a nitrogen plasma. There are four main benefits. First, the cost as compared with the classical methods is low, mainly because of the low energy requirements that must be attributed to the practically complete progression of the reaction itself; second, harmful substances and waste material are not incurred; third, the nanostructure permits an unsurpassed efficiency or fineness; and finally, a reaction can be achieved under controlled stoichiometry. Over and above this, the yield is very close to 100%, because the entire powder can be directly used, without having to be sorted out, comminuted or treated in any other way.

The method according to the invention is applied as follows: An indium and tin batch is weighed at the ratios calculated, so that the desired oxygen content is developed in the subsequent reaction. The constituents are melted and then introduced into an air or oxygen plasma in the form of a jet of a Newtonian fluid (jet in free fall). The plasma that comprises molecules, ions and atoms (O²⁺, O⁺, O₂, O, In, In⁺, Sn, and Sn⁺) as well as electrons is blown at by a supersonic nozzle. Contrary to the basic methods mentioned above, the free flight path is very long. It is about 5 meters for ITO.

The powder is collected when it is cold and is filled into an evacuated and sealed container. Subsequently, the container is subjected to a hot pressing process or a cold pressing process, which is followed by a sintering process. Pressing can be carried out unidirectionally on a press or isostatically in a HIP safety housing. Since it was used in the nanopowder state, the powder must be treated at a temperature of a magnitude of only about 650° C. instead of temperatures of about 900° C. to 1150° C. according to the cited methods.

The method according to the invention was also applied to other materials under the same conditions. In this connection, reference is made to bismuth, tin and zinc oxides, which were sputtered directly in an oxygen plasma.

The method was used for the industrial production of aluminum of a particular quality, as well as of aluminum nitride, with the latter being produced in a nitrogen plasma. The sub-stoichiometric oxide of silicon (SiO) was manufactured with a shorter free flight path.

### INDUSTRIAL APPLICATION EXAMPLE 1

A 70 kg batch of an indium-tin alloy with a weight ratio of 89.69 to 10.30 percent is melted at 400° C. The liquid flows through a calibrated ceramic nozzle, that is 2.5 mm in diameter, in the form of a Newtonian fluid jet. It enters a pure oxygen plasma and is blown at by a supersonic nozzle. The form and diameter of the stainless steel chamber are selected such that they do not have any effect on the path of the powder. The free flight path is 5 meters. The nozzle is positioned such that the powder follows a kidney-shaped path, before it is sucked outside of the chamber. The powder is collected in an absolute filter. The mean diameter of the powder cannot be measured, but seems to be within a magnitude of several tens of Angstrom units, when observed under an electron microscope.

The powder is filled into an evacuated and sealed container. This container is accommodated in a hot-isostatic-pressing housing (mold) where it is exposed to a temperature cycle of 650° C. at 1400 bar for a duration of 2 hours. After being removed from the mold, the workpiece has solidified and can be treated easily. Its density is over 99% of theoretical.

### INDUSTRIAL APPLICATION EXAMPLE 2

A 500 kg batch of bismuth is filled into a melting crucible. Considering the oxidation tendency of liquid bismuth, the surface should preferably be protected. Since bismuth, when cooling down, expands but does not attack steel, the melting crucible consists of steel. Once the metal has reached a temperature that is 150° C. above its melting temperature, the stopper rod is pulled up. The plasma forms as soon as the jet acts as an electrode. The hourly throughput is 540 kg for a jet with a diameter of 2.5 mm and 500 mm melt column. The powder is collected as described above. The same production using zinc under the same conditions yields a throughput of 395 kg per hour. The same production using antimony yields a production volume of 366 kg per hour. In contrast, silicon was introduced into the plasma as powder in the form of a Newtonian fluid jet, with the plasma being charged via a helical conveyor.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method for producing a metal oxide powder or a semiconductor oxide powder, comprising oxidizing a metal or a semiconductor material for the oxide powder in an oxygen plasma, wherein the metal or semiconductor material assumes a function of a melt-down electrode, such that the metal or semiconductor material undergoes a dynamic, continuous and direct oxidation, wherein a time of flight of developing oxide particles in the plasma is sufficient for a complete oxidation reaction without any mechanical contact before cooling down completely, and wherein the oxidation step is followed by a controlled cooling phase.

2. The method according to claim 1, further comprising a powder compaction phase by sintering or hot pressing at a temperature in a range of about 550° C. to 800° C.

3. The method according to claim 2, wherein the temperature is in a range of about 600° C. to 700° C.

4. An oxide powder, comprising a nanopowder having a grain size of less than 0.5 μm, wherein grains of the nanopowder comprise crystallites smaller than 100 nm.

5. The oxide powder according to claim 4, wherein the nanopowder is formed of at least one oxide selected from the group consisting of indium-tin-oxide, tin oxide, bismuth oxide, zinc oxide, silicon oxide, and antimony oxide.

6. The oxide powder according to claim 5, wherein the silicon oxide is sub-stoichiometric.

7. An oxide powder, comprising a nanopowder having a grain size of less than 0.5 μm, wherein grains of the nanopowder comprise crystallites smaller than 100 nm, wherein the nanopowder is produced according to the method of claim 1.

8. The oxide powder according to claim 7, wherein the nanopowder is formed of at least one oxide selected from the group consisting of indium-tin-oxide, tin oxide, bismuth oxide, zinc oxide, silicon oxide, and antimony oxide.

9. The oxide powder according to claim 8, wherein the silicon oxide is sub-stoichiometric.

10. A solid comprising an oxide powder according to claim 4, wherein the solid has a density of at least 99% of theoretical density.

11. The solid according to claim 10, wherein the nanopowder is formed of at least one oxide selected from the group consisting of indium-tin-oxide, tin oxide, bismuth oxide, zinc oxide, silicon oxide, and antimony oxide.

12. The solid according to claim 10, wherein the solid is in a form of a sputter target.

13. A solid comprising an oxide nanopowder having a grain size of less than 0.5 μm, wherein grains of the nanopowder comprise crystallites smaller than 100 nm, the nanopowder being produced according to the method of claim 1, wherein the solid has a density of at least 99% of theoretical density.

14. The solid according to claim 13, wherein the nanopowder is formed of at least one oxide selected from the group consisting of indium-tin-oxide, tin oxide, bismuth oxide, zinc oxide, silicon oxide, and antimony oxide.

15. The solid according to claim 13, wherein the solid is in a form of a sputter target.

16. A method for producing a metal nitride powder or a semiconductor nitride powder, comprising nitriding a metal or a semiconductor material for the nitride powder in a nitrogen plasma, wherein the metal or semiconductor material assumes a function of a melt-down electrode, such that the metal or semiconductor material undergoes a dynamic, continuous and direct nitridation, wherein a time of flight of developing nitride particles in the plasma is sufficient for a complete nitridation reaction without any mechanical contact before cooling down completely, and wherein the nitriding step is followed by a controlled cooling phase.

17. A nitride powder, comprising a nanopowder having a grain size of less than 0.5 μm, wherein grains of the nanopowder comprise crystallites smaller than 100 nm.

18. The nitride powder according to claim 17, wherein the nanopowder is formed of at least one nitride selected from the group consisting of aluminum nitride and silicon nitride.

19. A nitride powder, comprising a nanopowder having a grain size of less than 0.5 μm, wherein grains of the nanopowder comprise crystallites smaller than 100 nm, wherein the nanopowder is produced according to the method of claim 16.

20. A solid comprising a nitride powder according to claim 19, wherein the solid has a density of at least 99% of theoretical density.

21. The solid according to claim 20, wherein the solid is in a form of a sputter target.

22. A solid comprising a nitride nanopowder having a grain size of less than 0.5 μm, wherein grains of the nanopowder comprise crystallites smaller than 100 nm, the nanopowder being produced according to the method of claim 16, wherein the solid has a density of at least 99% of theoretical density.

23. The solid according to claim 22, wherein the nanopowder is formed of aluminum nitride.
